(19) United States
(12) Patent Application Publication
(10) Pub. No.: US 2015/0032603 A1
(43) Pub. Date: Jan. 29, 2015

(54) CERTIFICATE-AUTHENTICATED, TAG-INITIATED DORMANT TRANSACTION APPLICATION APPARATUSES, METHODS AND SYSTEMS

(71) Applicant: VISA INTERNATIONAL SERVICE ASSOCIATION, San Francisco, CA (US)

(72) Inventor: Robert Rutherford, Foster City, CA (US)

(73) Assignee: VISA INTERNATIONAL SERVICE ASSOCIATION, San Francisco, CA (US)

(21) Appl. No.: 14/204,599

(22) Filed: Mar. 11, 2014

Related U.S. Application Data
(60) Provisional application No. 61/776,746, filed on Mar. 11, 2013.

(51) Int. Cl. G06Q 20/32; G06K 5/00

(52) U.S. Cl. CPC G06Q 20/3278; G06K 5/00
USPC 705/39

(57) ABSTRACT

The CERTIFICATE-AUTHENTICATED, TAG-INITIATED DORMANT TRANSACTION APPLICATION APPARATUSES, METHODS AND SYSTEMS (“DPA”) transforms NFC, virtual wallet, and authentication inputs into application launch instructions and transaction information outputs. In some implementations, this may be achieved via obtaining an indication that a user device is in proximity to an NFC tag, where the NFC tag is associated with a merchant. Based on the indication, contents of the NFC tag are obtained. The contents include an authentication certificate for the merchant. The NFC tag is authenticated using the authentication certificate, where the authenticating of the NFC tag generates an authentication result indicating a validity of the NFC tag. An application launch instruction is provided to the user device based on the authentication result. The application launch instruction is processed at the user device to open an application associated with the merchant on the user device.

### PRIORITY CLAIM

This application claims priority to U.S. provisional patent application Ser. No. 61/776,746 filed Mar. 11, 2013, attorney docket no. 433US01 entitled “Certificate Authenticated, Tag-Initiated Dormant Transaction Application Apparatuses, Methods and Systems,” which is herein incorporated by reference in its entirety.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address near field communication (NFC) application launching, and more particularly, include CERTIFICATE-AUTHENTICATED, TAG-INITIATED DORMANT TRANSACTION APPLICATION APPARATUSES, METHODS AND SYSTEMS.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Consumers may use electronic devices to assist with a number of e-commerce activities. Near field communication (NFC) tags can be used to make purchases at checkout.

### SUMMARY

The present disclosure is directed to a computer-implemented method, apparatus, system, and non-transitory computer-readable storage medium for automatically launching a transaction application. In an example method for automatically launching a transaction application, an indication that a user device is in proximity to an NFC tag is obtained, where the NFC tag is associated with a merchant. Based on the indication, contents of the NFC tag are obtained, where the contents include an authentication certificate for the merchant that is stored in the NFC tag. Using a processing system, the NFC tag is authenticated using the authentication certificate, where the authenticating of the NFC tag generates an authentication result indicating a validity of the NFC tag. An application launch instruction is provided to the user device based on the authentication result. The application launch instruction is processed at the user device to open an application associated with the merchant on the user device, where the application is configured to initiate a transaction with the merchant.

An example apparatus for automatically launching a transaction application includes a processor and a memory disposed in communication with the processor and storing processor-executable instructions. The processor-executable instructions, when executed, cause the processor to obtain an indication that a user device is in proximity to an NFC tag, the NFC tag being associated with a merchant. The processor-executable instructions also cause the processor to obtain, based on the indication, contents of the NFC tag, where the contents include an authentication certificate for the merchant that is stored in the NFC tag. The processor-executable instructions also cause the processor to authenticate the NFC tag using the authentication certificate, where the authenticating of the NFC tag generates an authentication result indicating a validity of the NFC tag. The processor-executable instructions further cause the processor to provide an application launch instruction to the user device based on the authentication result and process the application launch instruction at the user device to open an application associated with the merchant on the user device. The application is configured to initiate a transaction with the merchant.

An example non-transitory computer-readable storage medium for automatically launching a transaction application includes computer executable instructions which, when executed, cause a processing system to execute steps. In executing the steps, an indication that a user device is in proximity to an NFC tag is obtained, where the NFC tag is associated with a merchant. Based on the indication, contents of the NFC tag are obtained, where the contents include an authentication certificate for the merchant that is stored in the NFC tag. Using a processing system, the NFC tag is authenticated using the authentication certificate, where the authenticating of the NFC tag generates an authentication result indicating a validity of the NFC tag. An application launch instruction is provided to the user device based on the authentication result. The application launch instruction is processed at the user device to open an application associated with the merchant on the user device, where the application is configured to initiate a transaction with the merchant.

An example system for automatically launching a transaction application includes means for obtaining an indication that a user device is in proximity to an NFC tag, where the NFC tag is associated with a merchant. The example system also includes means for obtaining, based on the indication, contents of the NFC tag, where the contents include an authentication certificate for the merchant that is stored in the NFC tag. The example system further includes means for authenticating the NFC tag using the authentication certificate, where the authenticating of the NFC tag generates an authentication result indicating a validity of the NFC tag. The example system also includes means for providing an application launch instruction to the user device based on the authentication result and means for processing the application launch instruction at the user device to open an application associated with the merchant on the user device. The application is configured to initiate a transaction with the merchant.

### BRIEF DESCRIPTION OF THE DRAWINGS

The accompanying appendices and/or drawings illustrate various non-limiting, example, innovative aspects in accordance with the present descriptions:

FIG. 1 shows a block diagram illustrating example embodiments of the DPA;

FIGS. 2a-b show data flow diagrams illustrating initiating an authenticated NFC transaction in some embodiments of the DPA;

FIGS. 3a-c show logic flow diagrams illustrating initiating an authenticated NFC transaction in some embodiments of the DPA;

FIG. 4 shows a data flow diagram illustrating initiating an authenticated NFC transaction with a merchant point-of-sales device in some embodiments of the DPA;

FIGS. 5a-b show logic flow diagrams illustrating initiating an authenticated NFC transaction with a merchant point-of-sales device in some embodiments of the DPA; and

FIG. 6 shows a block diagram illustrating embodiments of a DPA controller.

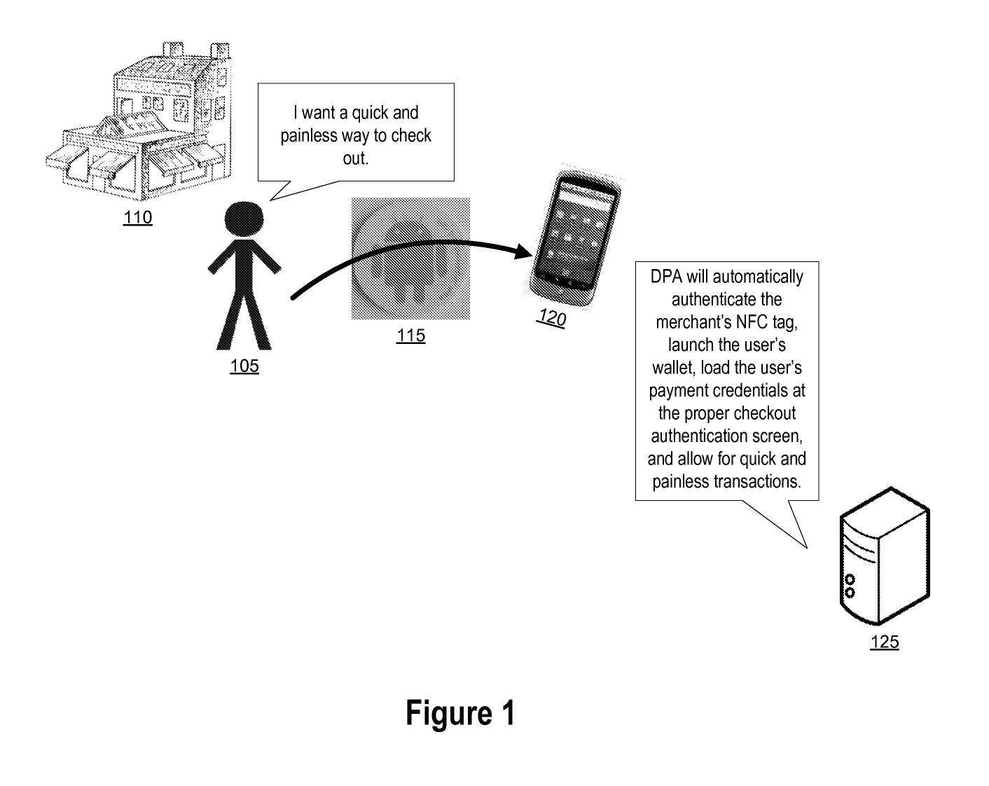

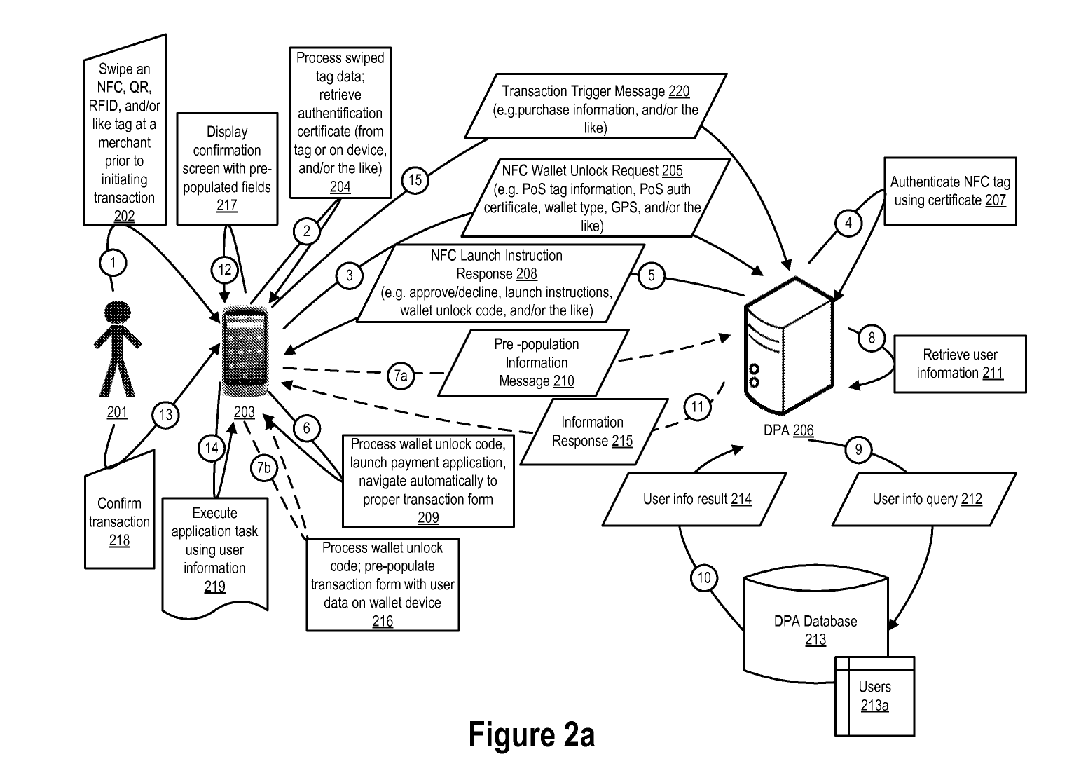

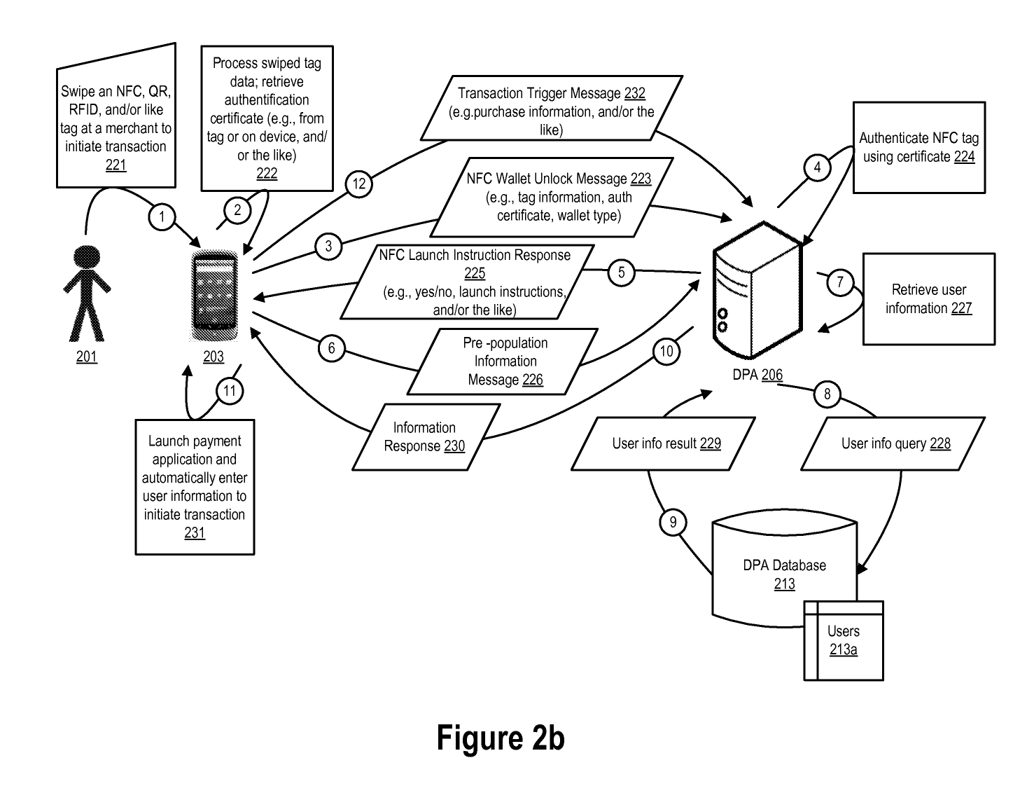

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

FIG. 1 shows a block diagram illustrating example embodiments of the DPA. In some implementations, a user 105 may wish to quickly check out and/or perform a like transaction at a merchant 110 using his electronic device 120. In some implementations, the user may do so with DPA 125, via swiping their electronic device (which may be used to access their virtual wallet and/or the like) across a transaction NFC tag 115, specific to the merchant, which may automatically unlock the user's device, open the correct application on the user's device, pre-populate the relevant transaction details, and carry out the transaction for the user.

FIGS. 2a-b show data flow diagrams illustrating initiating an authenticated NFC transaction in some embodiments of the DPA. In some implementations, a user 201 may choose an item for purchase (e.g., via scanning it with his electronic device 203, via selecting it via the user's virtual wallet, and/or the like), and may wish to check out. The user may swipe 202 a NFC, radio-frequency identification (RFID), and/or like tag that may be broadcasting a signal, using his virtual wallet-enabled electronic device. In some implementations, the device may process the swiped tag data via extracting and/or parsing the information 204 from the tag, and may extract an authentication certificate, code, and/or like from the tag. In some implementations, the authentication certificate may originate from a merchant, a payment network, an acquirer, an issuer, and/or a like entity. In some implementations, the user may also receive an authentication certificate and/or the like directly from a merchant when entering the store that may be used to verify the tag at checkout. In some implementations, the device may send an NFC wallet unlock request 205 to the DPA 206. In some implementations, the NFC wallet unlock request 205 may be an XML-encoded message that may take a form similar to the following:

```
POST /NFC_wallet_unlock_message.php HTTP/1.1
Host: www.DPAproccess.com
Content-Type: Application/XML
Content-Length: 788
<?XML version = “1.0” encoding = “UTF-8”?>
<NFC_wallet_unlock_message>
<timestamp>2016-01-01 12:30:00</timestamp>
    <user_params>
            <user_ID>123456789</user_ID>
            <user_password>********</user_password>
            <wallet_ID>A2C4E6G8I</wallet_ID>
    </user_params>
    <NFC_params>
        <NDEF_data>... 9C 00 9F1F AC1F 50 ...</NDEF_data>
        <NFC_id>4d46a5c6</NFC_id>
        <NFC_instruction>launch_application</NFC_instruction>
        <NFC_certificate>464784dfadfb8f4ef8c8bd4f5da4fda
        </NFC_certificate>
    </NFC_params>
<NFC_wallet_unlock_message>
```

In some implementations, any ISO 14443 protocols may be used in the NDEF data stream (e.g. Visa Paywave, EMVCO contactless, and/or the like). In some implementations, example protocol values for the EMVCO contactless platform may 4 resemble those in the table below:

TABLE A
Example NFC Data Stream Protocol

| Data Element Name | Tag # | Source/Value |
|---|---|---|
| . . . | . . . | . . . |
| Transaction Type | ‘9C’ | Purchase - ‘00’ |
| | (RFU (00000000b)) | Cash Advance - ‘01’ |
| | | Refund - ‘20’ |
| | | . . . |
| Track 1 Discretionary | ‘9F1F | Card/Electronic Device |
| Data | (RFU (00000000b)) | |
| Application Launch | AC1F | Card/Electronic Device |
| | (RFU (00000000b)) | |
| Application Label | ‘50’ | Card/Electronic Device |
| | (RFU (00000000b)) | |

In some implementations, DPA may authenticate the NFC tag to ensure that it is a valid merchant checkout tag via authenticating the authentication certificate bundled with the tag 207. In some implementations DPA may send an NFC launch instruction response 208, which may be embodied in an XML-encoded message that may take a form similar to the following:

```
POST / NFC_launch_instruction_response.php HTTP/1.1
Host: www.DPAproccess.com
Content-Type: Application/XML
Content-Length: 788
<?XML version = “1.0” encoding = “UTF-8”?>
<NFC_launch_instruction_response>
<timestamp>2016-01-01 12:30:00</timestamp>
    <user_params>
            <user_ID>123456789</user_ID>
            <user_password>********</user_password>
            <wallet_ID>A2C4E6G8I</wallet_ID>
            <device_unlock_code>1234</device_unlock_code>
    </user_params>
    <NFC_params>
        <NFC_id>4d46a5c6</NFC_id>
        /*optionally <NDEF_data>... 9C 00 9F1F AC1F 50 ...
        </NDEF_data>*/
        <NFC_valid>true</NFC_valid>
        <NFC_instruction>open_wallet_payment_application,
prepopulate=true, confirm=true, prepop_app_page=”.../
confirm.html”</NFC_instruction>
    </NFC_params>
<NFC_launch_instruction_response>
```

In some implementations, the device may use the information in the launch instruction response to process 209 the wallet unlock code, launch the payment application necessary for the particular merchant and/or the payment module of the virtual wallet application, and/or the like, and may automatically navigate to the proper transaction form. In some implementations, the wallet and/or application, based on the information in the instruction response, may send a pre-population information message 210 to DPA to get all the transaction information (e.g. user payment information, and/or the like) necessary to process the transaction in the launched application. In some implementations an XML-encoded pre-population information message 210 may take a form similar to the following:

```
POST / pre_population_information_request.php HTTP/1.1
Host: www.DPAproccess.com
Content-Type: Application/XML
Content-Length: 788
<?XML version = “1.0” encoding = “UTF-8”?>
<pre_population_information_request>
<timestamp>2016-01-01 12:30:00</timestamp>
    <user_params>
            <user_ID>123456789</user_ID>
            <user_password>********</user_password>
            <wallet_ID>A2C4E6G8I</wallet_ID>
            <device_unlock_code>1234</device_unlock_code>
    </user_params>
    <NFC_params>
        <NFC_id>4d46a5c6</NFC_id>
        /*optionally <NDEF_data>... 9C 00 9F1F AC1F 50 ...
        </NDEF_data>*/
        <NFC_valid>true</NFC_valid>
        <NFC_instruction>open_wallet_payment_application,
prepopulate=true, confirm=true, prepop_app_page=”.../
confirm.html”</NFC_instruction>
    </NFC_params>
<pre_population_information_request>
```

In some implementations, DPA may then retrieve 211 the user information necessary to process the transaction via sending a user information query 212 to the DPA database 213. In some implementations, the information query 212 may be a PHP-encoded message taking a form similar to the following:

```
<?php
      ...
          $user_id = “123456789”;
          $exp_result = mysql_query(“FROM users WHERE
          user_ID=’$user_id’ SELECT *);
>
```

The DPA database may send a user information result 214 which may contain the user's payment information, e.g., credit card data and/or the like. DPA may then send the data to the device via information response 215. In some implementations, the device may have the user's payment information already stored in the device's memory (e.g. in the virtual wallet on the user device, and/or the like) 216. The device may then display 217 a confirmation screen with all the fields in the launched application pre-populated with the pertinent information. The user may confirm 218 the transaction, and the user's device may then execute the application task 219 (e.g., the transaction) with the user's payment information via sending a transaction trigger message 220 to the DPA. In some implementations, an XML-encoded transaction trigger message may take a form similar to the following:

```
POST /transaction_trigger_message.php HTTP/1.1
Host: www.DPAproccess.com
Content-Type: Application/XML
Content-Length: 788
<?XML version = “1.0” encoding = “UTF-8”?>
<transaction_trigger_message>
<timestamp>2016-01-01 12:30:00</timestamp>
    <user_params>
            <user_ID>123456789</user_ID>
            <user_password>********</user_password>
            <wallet_ID>A2C4E6G8I</wallet_ID>
    </user_params>
    <NFC_params>
        <NFC_id>4d46a5c6</NFC_id>
        /*optionally <NDEF_data>... 9C 00 9F1F AC1F 50 ...
        </NDEF_data>*/
        <NFC_valid>true</NFC_valid>
        <NFC_instruction>open_wallet_payment_application,
prepopulate=true, confirm=true, prepop_app_page=”.../
confirm.html”</NFC_instruction>
    </NFC_params>
    <transaction_params>
            <merchant_ID>6344768487687434</merchant_ID>
            <user_payment_source>
                <payment_type>credit, Visa</payment_type>
                <payment_payee>John Smith</payment_payee>
                <payment_id>1234567890111213</payment_id>
                    <payment_exp_date>2018-01
                    </payment_exp_date>
                    <payment_sec_code>123</payment_sec_code>
                </user_payment_source>
                <transaction_amount>10.50</transaction_amount>
                <action>payment</action>
    </transaction_params>
<transaction_trigger_message>
```

In some implementations, as shown in FIG. 2b, a user 201 may choose an item for purchase (e.g., via scanning it with his electronic device 203, via selecting it via the user's virtual wallet, and/or the like), and may wish to check out. The user may swipe 221a NFC, QR, RFID, and/or like tag or code, using his virtual wallet-enabled electronic device. In some implementations, the device may process the swiped tag data via extracting and/or parsing the information 222 from the tag, and may extract an authentication certificate, code, and/or like from the tag. In some implementations, the user may also receive an authentication certificate and/or the like directly from a merchant when entering the store that may be used to verify the tag at checkout. In some implementations, the device may send an NFC wallet unlock request 223 to the DPA 206. In some implementations, the NFC wallet unlock request 223 may be an XML-encoded message that may take a form similar to that of NFC wallet unlock request 205.

In some implementations, DPA may authenticate the NFC tag to ensure that it is a valid merchant checkout tag via authenticating the authentication certificate bundled with the tag 224. In some implementations DPA may send an NFC launch instruction response 225, which may be embodied in an XML-encoded message that may take a form similar to NFC launch instruction response 208.

In some implementations, the wallet and/or application, based on the information in the instruction response, may send a pre-population information message 226 to DPA to get all the transaction information (e.g. user payment information, and/or the like) necessary to process the transaction in the launched application. In some implementations an XML-encoded pre-population information message 226 may take a form similar to that of pre-population information message 210.

In some implementations, DPA may then retrieve 227 the user information necessary to process the transaction via sending a user information query 228 to the DPA database 213. In some implementations, the information query 228 may be a PHP-encoded message taking a form similar to user information query 212.

The DPA database may send a user information result 229 which may contain the user's payment information, e.g., credit card data and/or the like. DPA may then send the data to the device via information response 230. In some implementations, the device may have the user's payment information already stored in the device's memory (e.g. in the virtual wallet on the user device, and/or the like). The device may then launch and execute the application task 231 (e.g., the transaction) with the user's payment information via sending a transaction trigger message 232 to the DPA. In some implementations, an XML-encoded transaction trigger message may take a form similar to transaction trigger message 220.

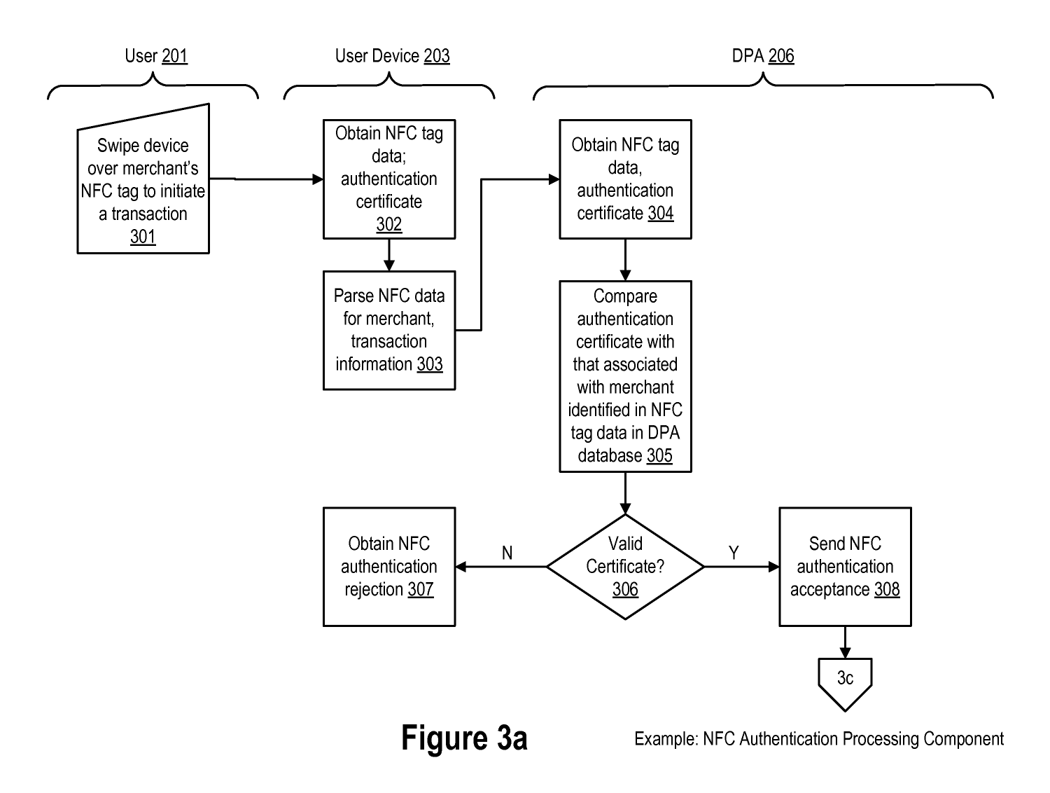

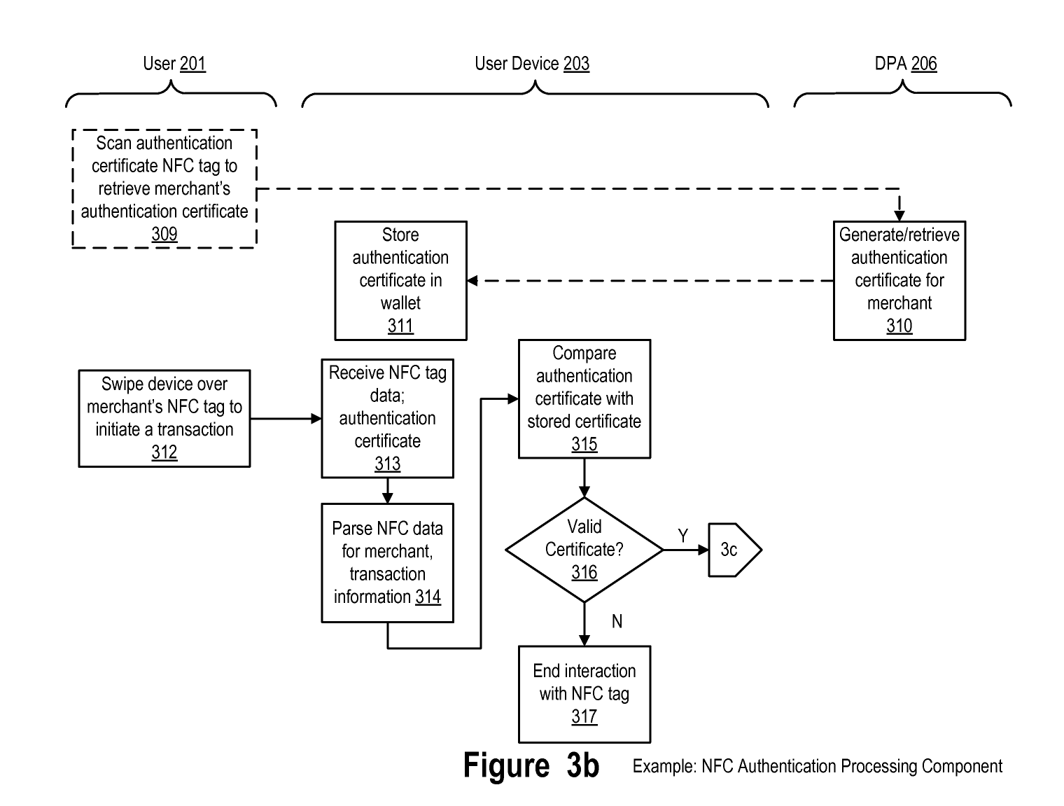

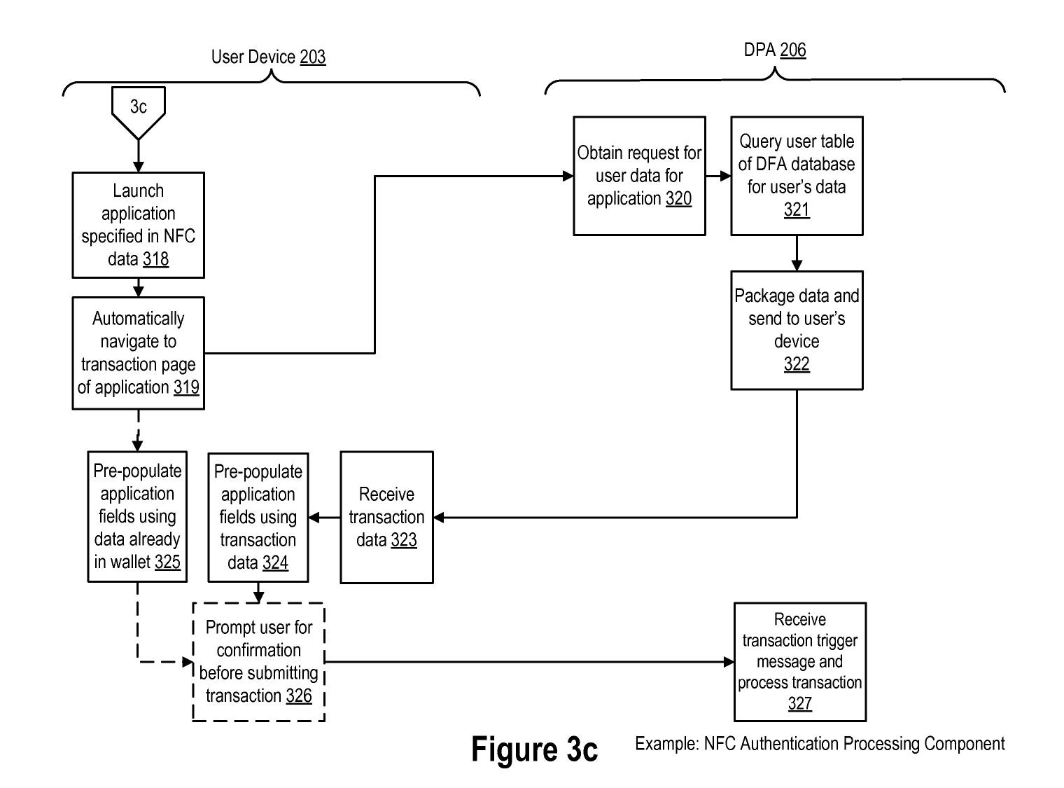

FIGS. 3a-c show logic flow diagrams illustrating initiating an authenticated NFC transaction in some embodiments of the DPA. In some implementations, the user may swipe 301 his electronic device over the NFC transaction tag in order to initiate a transaction with the merchant. The user device may obtain information out of the NFC tag 302, including an authentication certificate, and/or the like. The device may parse the data to obtain information about the merchant, transaction information (e.g., the merchant's acquirer, the payment application to open, and/or the like) 303. DPA may obtain the NFC tag data and the authentication certificate 304, and may compare the authentication certificate from the NFC tag with a certificate on DPA, in order to determine whether the certificate is valid, and therefore whether the tag is a valid merchant NFC transaction tag. In some implementations, the authentication certificate on DPA may be stored in a certificate table in the DPA database, and may be linked to the merchant's record in the database. In some implementations, if the certificate has been determined by DPA to be invalid 306, the user device may obtain 307 a message indicating that the NFC tag is invalid, and therefore the NFC authentication attempt has been rejected. If the certificate is valid, DPA may instead send an NFC authentication acceptance message to the user's device.

With regard to FIG. 3c, the user device may, using the launch application instructions specified in NFC data 318, launch the appropriate application for the transaction, and may automatically 319 navigate to the proper transaction page of the application to allow the user to confirm the transaction. In some implementations, the user device may already have the user's transaction data (e.g. user credit card information, and/or the like) in memory and/or in the wallet application, and may automatically 325 pre-populate the application fields using that data. In other implementations, DPA may obtain a request 320 for user data for the application, if the user device does not already have the data. The DPA may query the user table of the DPA database in order to retrieve the user's data. DPA may then package and send 322 the user data to the user's device via an information response to the device. The device may receive 323 the transaction data and may prepopulate 324 the launched application fields with the appropriate data. The device may then prompt the user to confirm the transaction 326 before sending a message to DPA in order to inform DPA that the user has confirmed the transaction. DPA may then process 327 the transaction.

With regard to FIG. 3b, in some implementations, the user may scan 309 an authentication certificate NFC tag, receive a wallet notification to download a merchant authentication certificate, and/or the like, and may retrieve a merchant's authentication certificate via sending a message to DPA in order to retrieve the certificate. DPA may generate a certificate 310 for the merchant and/or may retrieve an existing merchant certificate from the DPA database, and may send the certificate to the user's device, which may store 311 the authentication certificate in the user's wallet and/or the like. In some implementations, the user may then swipe 312 a merchant's NFC tag to initiate a transaction. The user's device may receive the NFC tag data and the NFC tag's authentication certificate 313 from the swipe, and may parse 314 the NFC tag data to determine application launch instructions and/or like transaction information. The user device may also compare 315 the authentication certificate from the NFC tag from the certificate stored in the wallet and/or the like. If the certificate is invalid 316, the device may end its interaction with the NFC tag 317, and may notify the user that the NFC tag was invalid, if the certificate is valid, the device may perform the actions outlined in FIG. 3c.

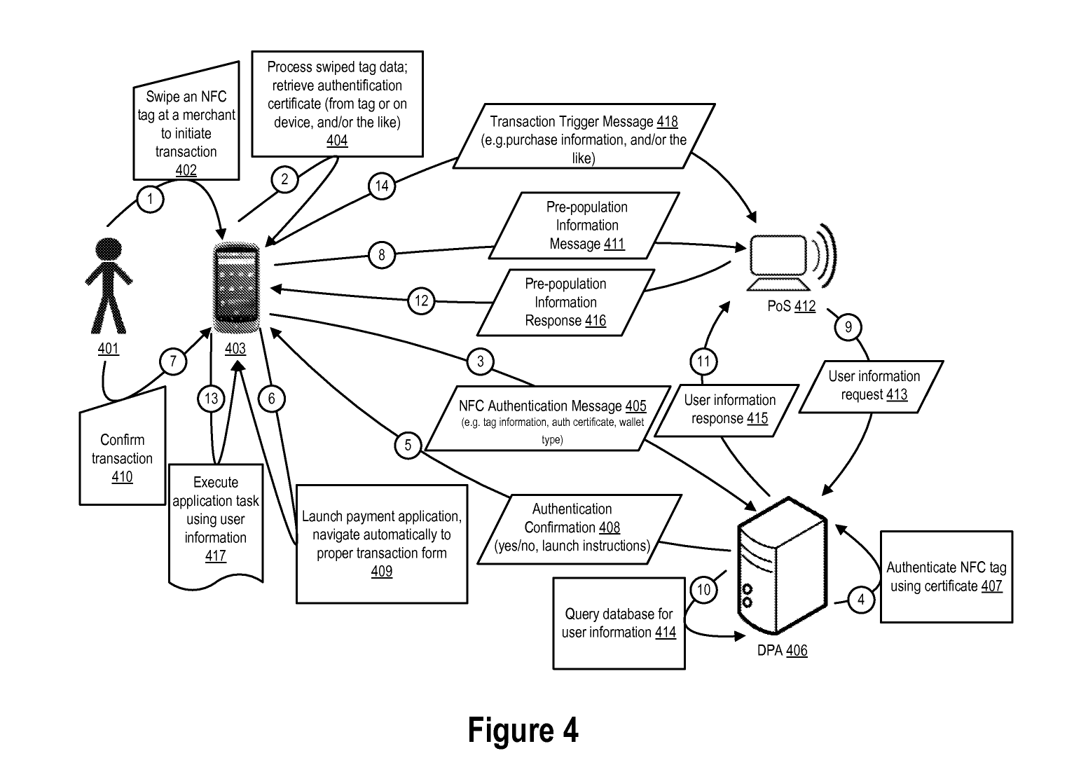

FIG. 4 shows a data flow diagram illustrating initiating an authenticated NFC transaction with a merchant point-of-sales device in some embodiments of the DPA. In some implementations, a user 401 may choose an item for purchase (e.g., via scanning it with his electronic device 403, via selecting it via the user's virtual wallet, and/or the like), and may wish to check out. The user may swipe 402 a NFC, QR, RFID, and/or like tag or code, using his virtual wallet-enabled electronic device. In some implementations, the device may process the swiped tag data via extracting and/or parsing the information 404 from the tag, and may extract an authentication certificate, code, and/or like from the tag. In some implementations, the user may also receive an authentication certificate and/or the like directly from a merchant when entering the store that may be used to verify the tag at checkout. In some implementations, the device may send an NFC authentication message 405 to the DPA 406. In some implementations, the NFC authentication 405 may be an XML-encoded message that may take a form similar to that of NFC wallet unlock request 205. In some implementations, DPA may authenticate the NFC tag to ensure that it is a valid merchant checkout tag via authenticating the authentication certificate bundled with the tag 407. In some implementations DPA may send an authentication confirmation 408, which may be embodied in an XML-encoded message that may take a form similar to that of NFC launch instruction response.

In some implementations, the device may use the information in the launch instruction response to process 409 the wallet unlock code, launch the payment application necessary for the particular merchant and/or the payment module of the virtual wallet application, and/or the like, and may automatically navigate to the proper transaction form. In some implementations, the wallet and/or application, based on the information in the instruction response, and after receiving confirmation 410 from the user to initiate the transaction, may send a pre-population information message 411 to the merchant's point-of-sales (PoS) device to get all the transaction information (e.g. user payment information, and/or the like) necessary to process the transaction in the launched application. In some implementations an XML-encoded pre-population information message 411 may take a form similar to that of pre-population information message 210. In some implementations, the PoS may send a user information request 413 to DPA. In some implementations, the user information request 413 may take a form similar to the following:

```
POST / pre_population_information_request.php HTTP/1.1
Host: www.DPAproccess.com
Content-Type: Application/XML
Content-Length: 788
<?XML version = “1.0” encoding = “UTF-8”>
<pre_population_information_request>
<timestamp>2016-01-01 12:30:00</timestamp>
    <user_params>
            <user_ID>123456789</user_ID>
            <user_password>********</user_password>
            <wallet_ID>A2C4E6G8I</wallet_ID>
            <device_unlock_code>1234</device_unlock_code>
    </user_params>
    <NFC_params>
        <NFC_id>4d46a5c6</NFC_id>
        /*optionally <NDEF_data>... 9C 00 9F1F AC1F 50 ...
        </NDEF_data>*/
        <NFC_valid>true</NFC_valid>
        <NFC_instruction>open_wallet_payment_application,
prepopulate=true, confirm=true, prepop_app_page=”.../confirm.html”
</NFC_instruction>
    </NFC_params>
<pre_population_information_request>
```

In some implementations, DPA may query 414 the DPA database for the pertinent user transaction information, and may send the information to the PoS via a user information result 416. In some implementations the PoS may send the data to the device via pre-population information response 416. In some implementations, the device executes the application task 417 (e.g., the transaction) with the user's payment information via sending a transaction trigger message 418 to the PoS.

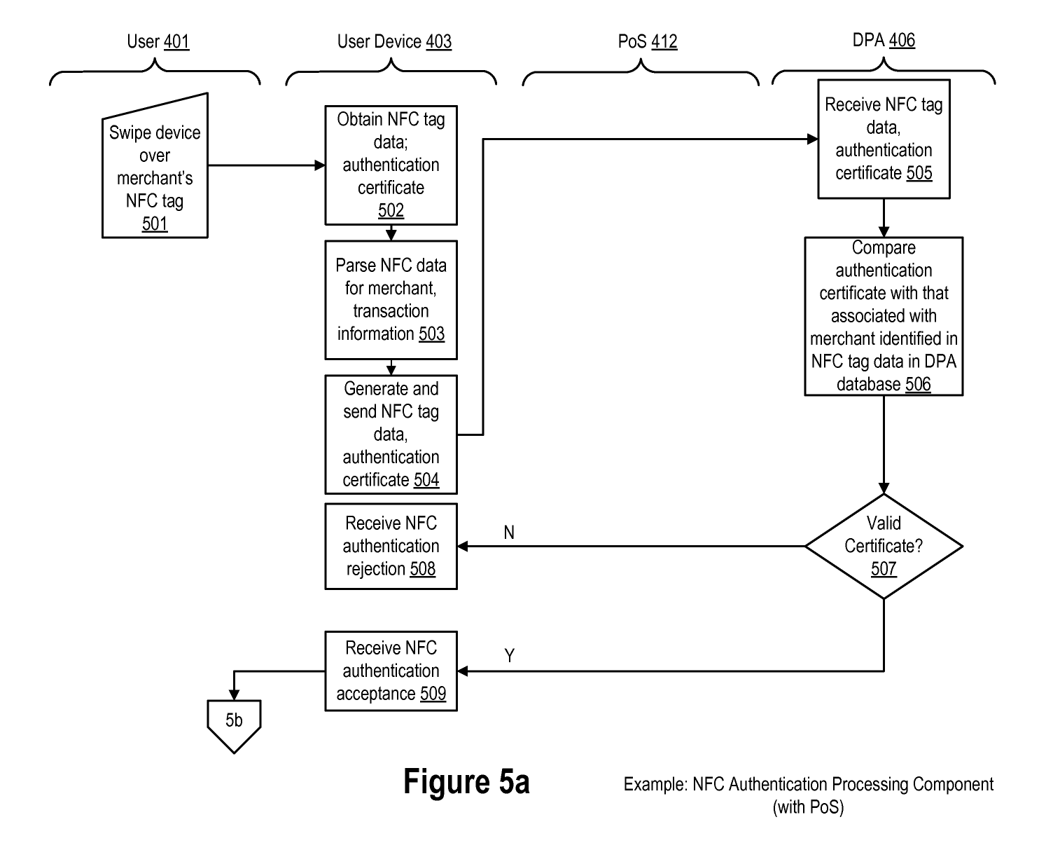

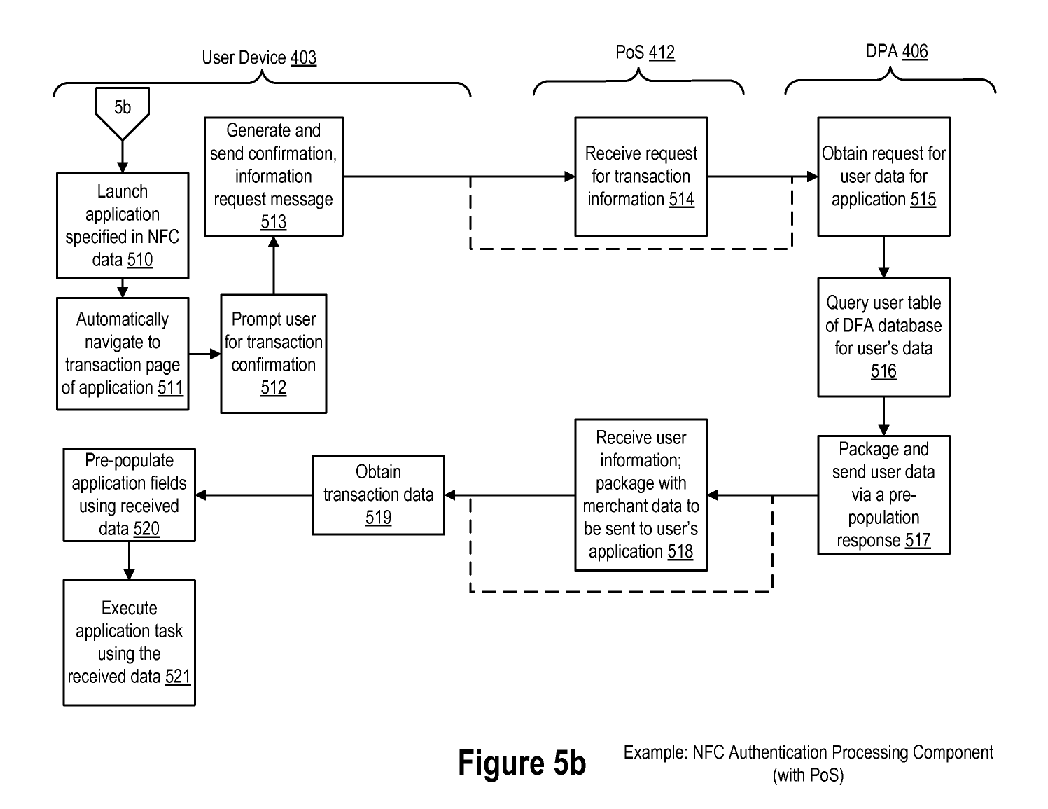

FIGS. 5a-b show logic flow diagrams illustrating initiating an authenticated NFC transaction with a merchant point-of-sales device in some embodiments of the DPA. In some implementations, a user may swipe his device 501 over the merchant's NFC tag in order to initiate a transaction. The user's device may obtain the NFC tag data 502 and an authentication certificate in the NFC tag, and may parse 503 the NFC tag data for merchant and transaction-relevant information (e.g. which application to launch, merchant payment information, and/or the like). The user device may generate and send 504 a message to DPA with the NFC tag data, authentication certificate, and/or the like. DPA may receive 505 the NFC tag data, authentication certificate, and/or the like, and may compare 506 the authentication certificate from the NFC tag with that associated with the merchant in the DPA database. If the certificate is invalid 507, the user's device may obtain a notification 508 indicating that the certificate was invalid and therefore the NFC tag has been rejected by DPA. If the certificate is valid, then the user device may instead receive a notification 509 indicating that the NFC tag is valid, and may launch 510 the application specified by the NFC tag data. The device automatically navigates 511 to the transaction confirmation page for the application specified by the NFC tag, and may prompt 512 the user to confirm the transaction. If the user confirms the transaction, the device may generate and send 513 an information request message to the merchant's PoS device with the NFC tag information and the user's transaction confirmation, and the PoS may receive 514 and forward the transaction information to DPA, which may obtain the request for user data for the transaction from the PoS 515 and may query the user table in the DPA database 516 for the pertinent information. In some implementations, DPA may package and send the user data via a pre-population response 517 back to the PoS device, which may receive the information and, along with the merchant data on the PoS, may send all the transaction data 518 to the user's device. After the user device has obtained the transaction data 519, the device may pre-populate all the transaction application fields 520 using the received user and merchant data, and may execute 521 the application task (e.g. the transaction) using the data.

### DPA Controller

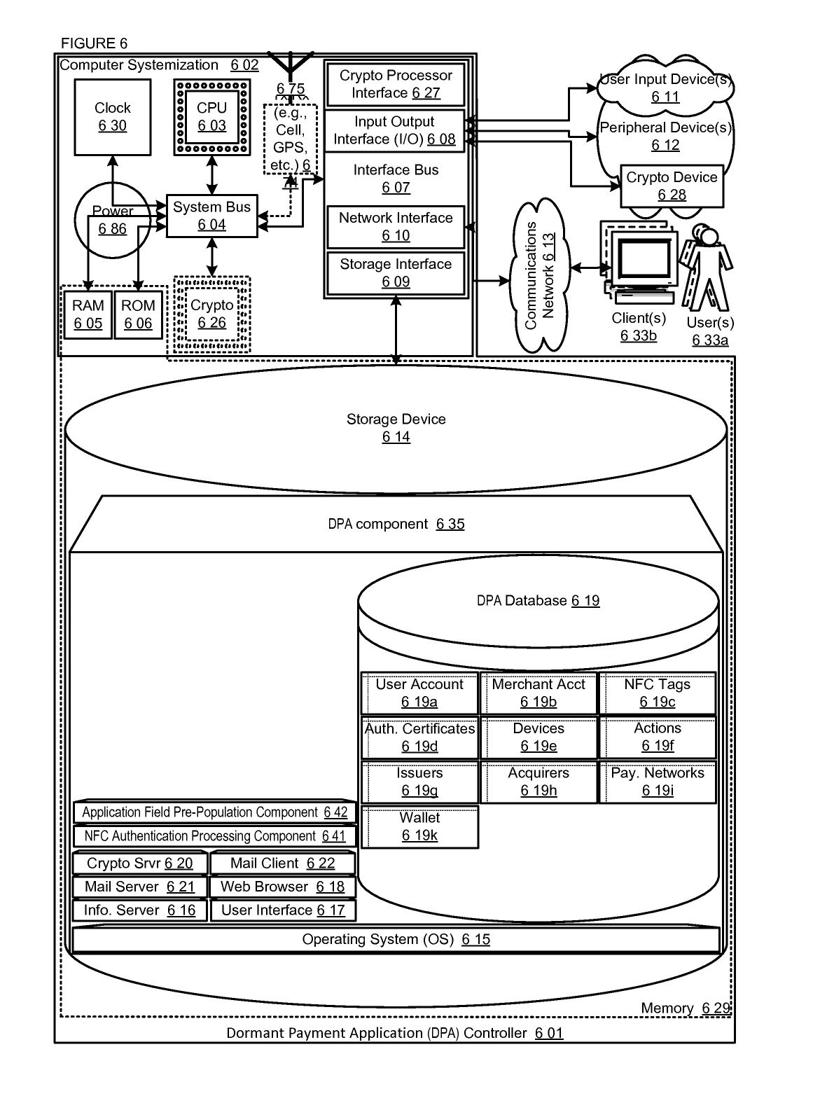

FIG. 6 shows a block diagram illustrating embodiments of a DPA controller. In this embodiment, the DPA controller 601 may serve to aggregate, process, store, search, serve, identify, instruct, generate, match, and/or facilitate interactions with a computer through NFC and virtual wallet technologies, and/or other related data.

Typically, users, which may be people and/or other systems, may engage information technology systems (e.g., computers) to facilitate information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the DPA controller 601 may be connected to and/or communicate with entities such as, but not limited to: one or more users from user input devices 611; peripheral devices 612; an optional cryptographic processor device 628; and/or a communications network 613.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The DPA controller 601 may be based on computer systems that may comprise, but are not limited to, components such as: a computer systemization 602 connected to memory 629.

### Computer Systemization

A computer systemization 602 may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effectuate communications, operations, storage, etc. The computer systemization may be connected to a power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing DPA controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the DPA controller and beyond through various interfaces. Should processing requirements dictate a greater amount speed and/or capacity, distributed processors (e.g., Distributed DPA), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the DPA may be achieved by implementing a microcontroller such as CAST's R8051XC2 microcontroller; Intel's MCS 51 (i.e., 8051 microcontroller); and/or the like. Also, to implement certain features of the DPA, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the DPA component collection (distributed or otherwise) and/or features may be implemented via the microprocessor and/or via embedded components; e.g., via ASIC, coprocessor, DSP, FPGA, and/or the like. Alternately, some implementations of the DPA may be implemented with embedded components that are configured and used to achieve a variety of features or signal processing.

Depending on the particular implementation, the embedded components may include software solutions, hardware solutions, and/or some combination of both hardware/software solutions. For example, DPA features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the DPA features. A hierarchy of programmable interconnects allow logic blocks to be interconnected as needed by the DPA system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the DPA may be developed on regular FPGAs and then migrated into a fixed version that more resembles ASIC implementations. Alternate or coordinating implementations may migrate DPA controller features to a final ASIC instead of or in addition to FPGAs. Depending on the implementation all of the aforementioned embedded components and microprocessors may be considered the “CPU” and/or “processor” for the DPA.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the DPA thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

### Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the DPA controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed DPA), architectures may similarly be employed to pool, load balance, and/or otherwise increase the communicative bandwidth required by the DPA controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 611 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612 may be connected and/or communicate to I/O and/or other facilities of the like such as network interfaces, storage interfaces, directly to the interface bus, system bus, the CPU, and/or the like. Peripheral devices may be external, internal and/or part of the DPA controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the DPA controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the DPA controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the DPA controller and/or a computer systemization may employ various forms of memory 629. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server); the DPA component(s) 635, including components 641-642; and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

### Operating System

The operating system component 615 is an executable program component facilitating the operation of the DPA controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the DPA controller to communicate with other entities through a communications network 613. Various communication protocols may be used by the DPA controller as a subcarrier transport mechanism for interaction, such as, but not limited to: multicast, TCP/IP, UDP, unicast, and/or the like.

### Information Server

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the DPA controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the DPA database 619, operating systems, other program components, user interfaces, Web browsers, and/or the like.

Access to the DPA database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the DPA. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the DPA as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the DPA enabled nodes. The combined application may be nugatory on systems employing standard Web browsers.

### Mail Server

A mail server component 621 is a stored program component that is executed by a CPU 603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the DPA.

Access to the DPA mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the DPA may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the DPA component to engage in secure transactions if so desired. The cryptographic component facilitates the secure accessing of resources on the DPA and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The DPA Database

The DPA database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the DPA database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the DPA database is implemented as a data-structure, the use of the DPA database 619 may be integrated into another component such as the DPA component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-i and k. A user account table 619a includes fields such as, but not limited to: user_ID, user_name, user_password, user_fname, user_lname, user_address, user_wallet_ID, user_devices, user_email, user_date_added, and/or the like. The user account table may support and/or track multiple user accounts on a DPA. A merchant account table 619b includes fields such as, but not limited to: merchant_ID, merchant_store_injection_package, merchant_address, merchant_name, merchant_email, merchant_products, merchant_date_added, and/or the like. The merchant account table may support and/or track multiple merchant accounts on a DPA. A NFC tags table 619c includes fields such as, but not limited to: nfc_ID, nfc_merchant_ID, nfc_contents, nfc_name, nfc_type, nfc_locked, and/or the like. The NFC tags table may support and/or track multiple NFC tags utilized with a DPA. An authentication certificate table 619d includes fields such as, but not limited to: cert_ID, cert_NFC_ID, cert_code, cert_name, cert_origin, cert_merchant_ID, and/or the like. The authentication certificate table may support and/or track certificates connected with NFC tags on a DPA. A device table 619e includes fields such as, but not limited to: device_ID, device_user_ID, device_type, device_make, device_model, device_OS, device_name, and/or the like. The device table may support and/or track multiple user devices on a DPA. An actions table 619f includes fields such as, but not limited to: action_ID, action_code, action_decoded_action, action_NFC_protocol, and/or the like. The actions table may support and/or track multiple transaction NFC action codes on a DPA. An issuers table 619g includes fields such as, but not limited to: issuer_ID, issuer_name, issuer_address, issuer_certificates, and/or the like. The device table may support and/or track multiple issuer accounts on a DPA. An acquirers table 619h includes fields such as, but not limited to: acquirer_ID, acquirer_name, acquirer_address, acquirer_certificates, and/or the like. The device table may support and/or track multiple acquirer accounts on a DPA. A payment networks table 619i includes fields such as, but not limited to: pn_ID, pn_issuer_IDs, pn_acquirer_IDs, pn_merchant_IDs, pn_certificates, and/or the like. The device table may support and/or track multiple payment networks on a DPA. A wallet table 619k includes fields such as, but not limited to: wallet_ID, wallet_user_ID, wallet_user_password, wallet_user_username, wallet_type, and/or the like. The device table may support and/or track multiple virtual wallet accounts on a DPA.

In one embodiment, the DPA database may interact with other database systems. For example, employing a distributed database system, queries and data access by search DPA component may treat the combination of the DPA database, an integrated data security layer database as a single database entity.

In one embodiment, user programs may contain various user interface primitives, which may serve to update the DPA. Also, various accounts may require custom database tables depending upon the environments and the types of clients the DPA may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-k. The DPA may be configured to keep track of various settings, inputs, and parameters via database controllers.

The DPA database may communicate to and/or with other components in a component collection, including itself, and/or facilities of the like. Most frequently, the DPA database communicates with the DPA component, other program components, and/or the like. The database may contain, retain, and provide information regarding other nodes and data.

### The DPAs

The DPA component 635 is a stored program component that is executed by a CPU. In one embodiment, the DPA component incorporates any and/or all combinations of the aspects of the DPA that was discussed in the previous figures. As such, the DPA affects accessing, obtaining and the provision of information, services, transactions, and/or the like across various communications networks. The features and embodiments of the DPA discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the DPA's features and facilities, and in many cases reduce the costs, energy consumption/requirements, and extend the life of DPA's underlying infrastructure; this has the added benefit of making the DPA more reliable. Similarly, many of the features and mechanisms are designed to be easier for users to use and access, thereby broadening the audience that may enjoy/employ and exploit the feature sets of the DPA; such ease of use also helps to increase the reliability of the DPA. In addition, the feature sets include heightened security as noted via the Cryptographic components 620, 626, 628 and throughout, making access to the features and data more reliable and secure.

The DPA transforms NFC, virtual wallet, and authentication inputs via DPA's NFC Authentication Processing 641 and Application Field Pre-Population 642 components into application launch instructions and transaction information outputs.

The DPA component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the DPA server employs a cryptographic server to encrypt and decrypt communications. The DPA component may communicate to and/or with other components in a component collection, including itself, and/or facilities of the like. Most frequently, the DPA component communicates with the DPA database, operating systems, other program components, and/or the like. The DPA may contain, communicate, generate, obtain, and/or provide program component, system, user, and/or data communications, requests, and/or responses.

### Distributed DPAs

The structure and/or operation of any of the DPA node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the DPA controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the DPA controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until
end of message
do {
        $input = “”;
        $input = socket_read($client, 1024);
        $data .= $input;
} while($input != “”);
// parse data to extract variables
$obj = json_decode($data, true);
// store input data in a database
mysql_connect(″201.408.185.132″,$DBserver,$password);
// access database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example 18 embodiments regarding SOAP parser implementation

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for CERTIFICATE-AUTHENTICATED, TAG-INITIATED DORMANT TRANSACTION APPLICATION APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a DPA individual and/or enterprise user, database configuration and/or relational model, data type, data transmission and/or network framework, syntax structure, and/or the like, various embodiments of the DPA, may be implemented that enable a great deal of flexibility and customization. For example, aspects of the DPA may be adapted for launching non-commerce dormant applications, and/or the like. While various embodiments and discussions of the DPA have included NFC tags, it is to be understood that the embodiments described herein may be readily configured and/or customized for a wide variety of other applications and/or implementations, such as with QR, RFID, and/or bar codes.

What is claimed is:

1. A processor-implemented method for automatically launching a transaction application, the processor-implemented method comprising:
obtaining an indication that a user device is in proximity to an NFC tag, the NFC tag being associated with a merchant;
obtaining, based on the indication, contents of the NFC tag, the contents including an authentication certificate for the merchant that is stored in the NFC tag;
authenticating, via a processing system, the NFC tag using the authentication certificate, wherein the authenticating of the NFC tag generates an authentication result indicating a validity of the NFC tag;
providing an application launch instruction to the user device based on the authentication result; and
processing the application launch instruction at the user device to open an application associated with the merchant on the user device, the application being configured to initiate a transaction with the merchant.

2. The processor-implemented method of claim 1, wherein the application is opened without an input from a user of the user device, and wherein the opening of the application includes unlocking the user device based on the application launch instruction, the processor-implemented method further comprising:
automatically loading one or more transaction details in the application, the one or more transaction details populating one or more fields of the application and comprising information about the user required to complete the transaction.

3. The processor-implemented method of claim 2, wherein the one or more transaction details include:
a name of the user;
an address of the user; and
a payment credential of the user.

4. The processor-implemented method of claim 1, wherein the authenticating of the NFC tag includes:
transmitting the authentication certificate from the user device to a second device via a network, the second device including the processing system;
comparing, using the processing system, the authentication certificate to a second authentication certificate stored at the second device to generate the authentication result, wherein the second authentication certificate is associated with the merchant; and
transmitting the application launch instruction from the second device to the user device via the network.

5. The processor-implemented method of claim 1, wherein the opening of the application includes:
automatically opening a transaction form within the application, the transaction form being configured to accept information that is required to complete the transaction, wherein the transaction form is opened without an input from a user of the user device.

6. The processor-implemented method of claim 1, further comprising:
obtaining, via the application, a confirmation to complete the transaction, the confirmation being obtained from a user of the user device.

7. An apparatus for automatically launching a transaction application, the apparatus comprising:
a processor; and
a memory disposed in communication with the processor and storing processor-executable instructions to:
obtain an indication that a user device is in proximity to an NFC tag, the NFC tag being associated with a merchant;
obtain, based on the indication, contents of the NFC tag, the contents including an authentication certificate for the merchant that is stored in the NFC tag;
authenticate the NFC tag using the authentication certificate, wherein the authenticating of the NFC tag generates an authentication result indicating a validity of the NFC tag;
provide an application launch instruction to the user device based on the authentication result; and
process the application launch instruction at the user device to open an application associated with the merchant on the user device, the application being configured to initiate a transaction with the merchant.

8. The apparatus of claim 7, wherein the application is opened without an input from a user of the user device, and wherein the opening of the application includes unlocking the user device based on the application launch instruction, the processor-executable instructions including instructions to:
automatically load one or more transaction details in the application, the one or more transaction details populating one or more fields of the application and comprising information about the user required to complete the transaction.

9. The apparatus of claim 8, wherein the one or more transaction details include:
a name of the user;
an address of the user; and
a payment credential of the user.

10. The apparatus of claim 7, wherein the authenticating of the NFC tag includes:
transmitting the authentication certificate from the user device to a second device via a network;
comparing the authentication certificate to a second authentication certificate stored at the second device to generate the authentication result, wherein the second authentication certificate is associated with the merchant; and
transmitting the application launch instruction from the second device to the user device via the network.

11. The apparatus of claim 7, wherein the opening of the application includes:
automatically opening a transaction form within the application, the transaction form being configured to accept information that is required to complete the transaction, wherein the transaction form is opened without an input from a user of the user device.

12. The apparatus of claim 7, wherein the processor-executable instructions include instructions to:
obtain, via the application, a confirmation to complete the transaction, the confirmation being obtained from a user of the user device.

13. A non-transitory computer-readable storage medium for automatically launching a transaction application, the computer-readable storage medium comprising computer executable instructions which, when executed, cause a processing system to execute steps comprising:
obtaining an indication that a user device is in proximity to an NFC tag, the NFC tag being associated with a merchant;
obtaining, based on the indication, contents of the NFC tag, the contents including an authentication certificate for the merchant that is stored in the NFC tag;
authenticating the NFC tag using the authentication certificate, wherein the authenticating of the NFC tag generates an authentication result indicating a validity of the NFC tag;
providing an application launch instruction to the user device based on the authentication result; and
processing the application launch instruction at the user device to open an application associated with the merchant on the user device, the application being configured to initiate a transaction with the merchant.

14. The non-transitory computer-readable storage medium of claim 13, wherein the application is opened without an input from a user of the user device, and wherein the opening of the application includes unlocking the user device based on the application launch instruction, the computer executable instructions causing the processing system to execute the steps comprising:
automatically loading one or more transaction details in the application, the one or more transaction details populating one or more fields of the application and comprising information about the user required to complete the transaction.

15. The non-transitory computer-readable storage medium of claim 14, wherein the one or more transaction details include:
a name of the user;
an address of the user; and
a payment credential of the user.

16. The non-transitory computer-readable storage medium of claim 13, wherein the authenticating of the NFC tag includes:
transmitting the authentication certificate from the user device to a second device via a network;
comparing the authentication certificate to a second authentication certificate stored at the second device to generate the authentication result, wherein the second authentication certificate is associated with the merchant; and
transmitting the application launch instruction from the second device to the user device via the network.

17. The non-transitory computer-readable storage medium of claim 13, wherein the opening of the application includes:
automatically opening a transaction form within the application, the transaction form being configured to accept information that is required to complete the transaction, wherein the transaction form is opened without an input from a user of the user device.

18. The non-transitory computer-readable storage medium of claim 13, wherein the computer executable instructions cause the processing system to execute the steps comprising:
obtaining, via the application, a confirmation to complete the transaction, the confirmation being obtained from a user of the user device.

19. A system for automatically launching a transaction application, the system comprising:
means for obtaining an indication that a user device is in proximity to an NFC tag, the NFC tag being associated with a merchant;
means for obtaining, based on the indication, contents of the NFC tag, the contents including an authentication certificate for the merchant that is stored in the NFC tag;
means for authenticating the NFC tag using the authentication certificate, wherein the authenticating of the NFC tag generates an authentication result indicating a validity of the NFC tag;
means for providing an application launch instruction to the user device based on the authentication result; and
means for processing the application launch instruction at the user device to open an application associated with the merchant on the user device, the application being configured to initiate a transaction with the merchant.

20. The system of claim 19, wherein the application is opened without an input from a user of the user device, and wherein the opening of the application includes unlocking the user device based on the application launch instruction, the system further comprising:
means for automatically loading one or more transaction details in the application, the one or more transaction details populating one or more fields of the application and comprising information about the user required to complete the transaction.

21. The system of claim 20, wherein the one or more transaction details include:
a name of the user;
an address of the user; and
a payment credential of the user.

22. The system of claim 19, wherein the authenticating of the NFC tag includes:
transmitting the authentication certificate from the user device to a second device via a network;
comparing the authentication certificate to a second authentication certificate stored at the second device to generate the authentication result, wherein the second authentication certificate is associated with the merchant; and
transmitting the application launch instruction from the second device to the user device via the network.

23. The system of claim 19, wherein the opening of the application includes:
automatically opening a transaction form within the application, the transaction form being configured to accept information that is required to complete the transaction, wherein the transaction form is opened without an input from a user of the user device.

24. The system of claim 19, further comprising:
means for obtaining, via the application, a confirmation to complete the transaction, the confirmation being obtained from a user of the user device.
